(19) United States
(12) Patent Application Publication
(10) Pub. No.: US 2025/0322446 A1
(43) Pub. Date: Oct. 16, 2025

(54) TRANSACTION PROCESSING SYSTEM

(71) Applicant: TOSHIBA TEC KABUSHIKI KAISHA, Tokyo (JP)

(72) Inventor: Osamu Tsuchiya, Mishima Shizuoka (JP)

(21) Appl. No.: 19/015,825

(22) Filed: Jan. 10, 2025

(30) Foreign Application Priority Data
Apr. 12, 2024 (JP) 2024-064646

(51) Int. Cl. G06Q 30/0601

(52) U.S. Cl. CPC G06Q 30/0635

(57) ABSTRACT

According to one embodiment, a transaction processing system includes an update unit, a settlement unit, a judgement unit, and an introduction unit. The update unit updates, at each time when a merchandise item is designated through an operation by a customer, list data representing a list of transacted merchandise items to contain the merchandise item as a transacted merchandise item. The settlement unit settles a price of the transacted merchandise item contained in the list represented by the list data in response to a designation of a settlement. The judgement unit judges, at each time when the list data is updated by the update unit, a dish using a transacted merchandise item contained in a list represented by the updated list data. The introduction unit introduces a dish judged by the judging unit to the customer.

### CROSS-REFERENCE TO RELATED APPLICATION

This application is based upon and claims the benefit of priority from Japanese Patent Application No. 2024-064646, filed on Apr. 12, 2024, the entire contents of which are incorporated herein by reference.

### FIELD

Embodiments described herein relate generally to a transaction processing system, a transaction processing method, and a non-transitory computer storage medium.

### BACKGROUND

In response to requests from customers, introductions to the customers of recipes of dishes using merchandise items to be purchased by the customers are considered.

The introductions increase customer service quality, however, do not sufficiently promote sales.

Under the circumstances, an introduction is desired to a customer for whom a sales promotion is effective.

### DESCRIPTION OF THE DRAWINGS

FIG. 1 shows an entire configuration of a merchandise selling system according to one embodiment.

FIG. 2 is a block diagram showing a circuit configuration of a main part of a transaction processing apparatus in FIG. 1.

FIG. 3 is a block diagram showing a circuit configuration of a main part of a proposal processing apparatus.

FIG. 4 is a block diagram showing a circuit configuration of a main part of an information processing terminal.

FIG. 5 is a block diagram showing a circuit configuration of a main part of a POS server.

FIG. 6 shows a method of configuring a recipe database in FIG. 3.

FIG. 7 is a flowchart of transaction processing.

FIG. 8 is a flowchart of the transaction processing.

FIG. 9 shows an example of a registration window.

FIG. 10 is a sequence chart showing communications between the transaction processing apparatus and the proposal processing apparatus.

FIG. 11 shows an example of an introduction window.

FIG. 12 shows an example of the registration window.

### DETAILED DESCRIPTION

A challenge to be solved by the present disclosure is to provide a transaction processing system that can perform an introduction to a customer for whom a sales promotion is effective.

In general, according to one embodiment, a transaction processing system includes updating means, settling means, judging means, and introducing means. The updating means updates, at each time when a merchandise item is designated through an operation by a customer, list data representing a list of transacted merchandise items to contain the merchandise item as a transacted merchandise item. The settling means settles a price of the transacted merchandise item contained in the list represented by the list data in response to designation of a settlement. The judging means judges, at each time when the list data is updated by the updating means, a dish using a transacted merchandise item contained in a list represented by the updated list data. The introducing means introduces the dish judged by the judging means to the customer.

As below, a merchandise selling system performing processing relating to merchandise sales to customers in a store will be explained using the drawings. The merchandise selling system is an example of a transaction processing system processing merchandise sales as target transactions.

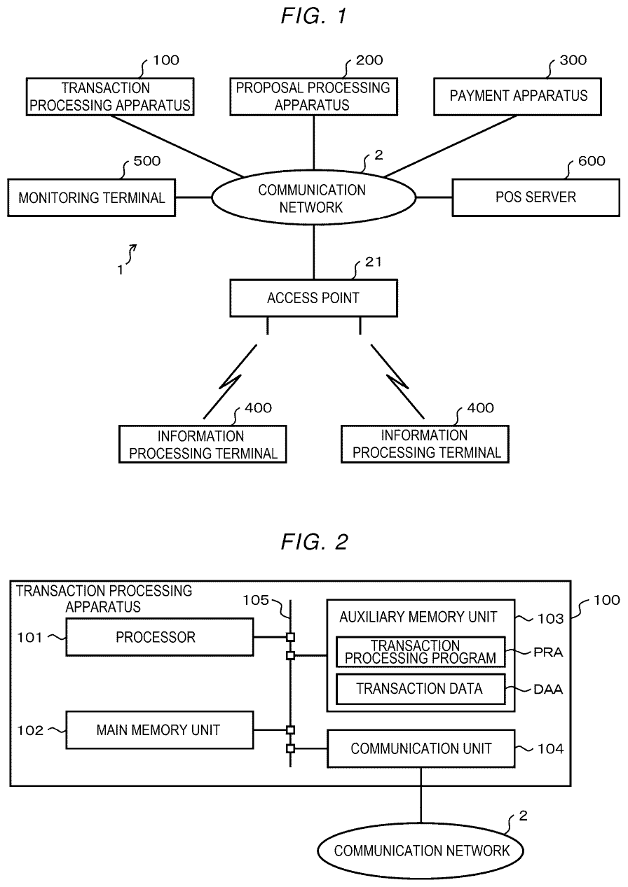

FIG. 1 shows an entire configuration of a merchandise selling system 1 according to the embodiment.

The merchandise selling system 1 includes a transaction processing apparatus 100, a proposal processing apparatus 200, a payment apparatus 300, information processing terminals 400, a monitoring terminal 500, and a POS (point-of-sale) server 600. The merchandise selling system 1 is configured to enable communication among the transaction processing apparatus 100, the information processing terminals 400, the monitoring terminal 500, and the POS server 600 via a communication network 2.

In FIG. 1, the single transaction processing apparatus 100, proposal processing apparatus 200, payment apparatus 300, monitoring terminal 500, and POS server 600 and the two information processing terminals 400 are shown, however, the numbers of the respective apparatuses are individually optional.

For the communication network 2, the Internet, a VPN (virtual private network), a LAN (local area network), a public telecommunication network, a mobile telecommunication network, etc. may be used alone or in an appropriate combination. As the communication network 2, as an example, the LAN, the Internet, and the mobile telecommunication network are combined and used. For example, the transaction processing apparatus 100, the payment apparatus 300, the information processing terminals 400, the monitoring terminal 500, and the POS server 600 are assumed to be used within a store. In this case, for example, the LAN is used for communication among the transaction processing apparatus 100, the payment apparatus 300, the information processing terminals 400, the monitoring terminal 500, and the POS server 600. Note that, in the embodiment, the information processing terminals 400 are connected to the communication network 2 by wireless access via an access point 21 contained in the communication network 2. For example, the Internet is used for the communication between the transaction processing apparatus 100 and the proposal processing apparatus 200.

Temporarily, a customer shopping within the store is an operator of the information processing terminal 400. For example, the information processing terminal 400 is attached to a shopping cart (hereinafter, simply referred to as “cart”). The information processing terminal 400 may be carried by a customer. As the information processing terminal 400, for example, an existing portable information processing apparatus such as a tablet computer, a smartphone, or a smartwatch may be used. The information processing terminal 400 provided in the store may be temporarily used by a customer or the terminal possessed by a customer may be used. Note that the information processing terminal 400 may be operated by a store clerk for a customer.

The transaction processing apparatus 100 registers a transacted merchandise item in response to an operation in the information processing terminal 400.

The proposal processing apparatus 200 is an information processing apparatus performing information processing for proposing a recipe to a customer using the information processing terminal 400.

The payment apparatus 300 is an information processing apparatus performing information processing for calculating a price of the transacted merchandise item registered with respect to one transaction in the transaction processing apparatus 100 and settling the price.

The monitoring terminal 500 is an information processing apparatus performing information processing for supporting a store clerk monitoring execution statuses of transactions in the merchandise selling system 1.

The POS server 600 is an information processing apparatus performing management relating to transactions processed in the merchandise selling system 1.

FIG. 2 is a block diagram showing a circuit configuration of a main part of the transaction processing apparatus 100.

The transaction processing apparatus 100 includes a processor 101, a main memory unit 102, an auxiliary memory unit 103, a communication unit 104, a transmission channel 105, and the like. The processor 101 can communicate with the main memory unit 102, the auxiliary memory unit 103, and the communication unit 104 via the transmission channel 105.

The processor 101, the main memory unit 102, and the auxiliary memory unit 103 are connected by the transmission channel 105 to form a computer performing information processing for controlling the transaction processing apparatus 100.

The processor 101 corresponds to a center part of the computer. The processor 101 executes information processing for controlling the respective units to implement various functions as the transaction processing apparatus 100 according to information processing programs including an operating system and an application program.

The main memory unit 102 corresponds to a main memory part of the computer. The main memory unit 102 includes a read-only memory area and a rewritable memory area. The main memory unit 102 stores part of the above described information processing program in the read-only memory area. Further, the main memory unit 102 may store data necessary for execution of processing for the processor 101 to control the individual units in the read-only memory area or the rewritable memory area. The main memory unit 102 uses the rewritable memory area as a work area for the processor 101.

The auxiliary memory unit 103 corresponds to an auxiliary memory part of the computer. For the auxiliary memory unit 103, for example, an EEPROM (electric erasable programmable read-only memory), an HDD (hard disc drive), an SSD (solid state drive), or other various known memory devices may be used. The auxiliary memory unit 103 stores data used by the processor 101 performing various kinds of processing and data generated by the processing in the processor 101. The auxiliary memory unit 103 may store the above described information processing program. In the embodiment, the auxiliary memory unit 103 stores a transaction processing program PRA as one of the information processing programs. The transaction processing program PRA is an application program described regarding a procedure of transaction processing, which will be described later. Part of the memory area of the auxiliary memory unit 103 is used as an area for storing transaction data DAA. The transaction data DAA is data representing details of one transaction.

The communication unit 104 executes communication processing for data communications via the communication network 2. As the communication unit 104, for example, an existing wired communication device for the Internet may be used. Note that, as the communication unit 104, a wireless communication device connected to the communication network 2 by wireless communication may be used in place of or in addition to the wired communication device.

The transmission channel 105 includes an address bus, a data bus, a control signal line, and the like, and transmits data and control signals transmitted and received between the individual connected units.

As basic hardware of the transaction processing apparatus 100, for example, a general-purpose server apparatus may be used. The transaction processing apparatus 100 is generally transferred with the transaction processing program PRA stored in the auxiliary memory unit 103. However, hardware without the transaction processing program PRA stored in the auxiliary memory unit 103 or with the same type of application program in another version stored in the auxiliary memory unit 103 and the transaction processing program PRA may be individually transferred. Further, the transaction processing program PRA may be written in the auxiliary memory unit 103 in response to an operation by a certain worker to form the transaction processing apparatus 100. The transaction processing program PRA may be transferred by recording in a removable disc such as a magnetic disc, a magnetooptical disc, an optical disc, or a semiconductor memory or by communication via a network. The transaction processing program PRA may be stored in the main memory unit 102.

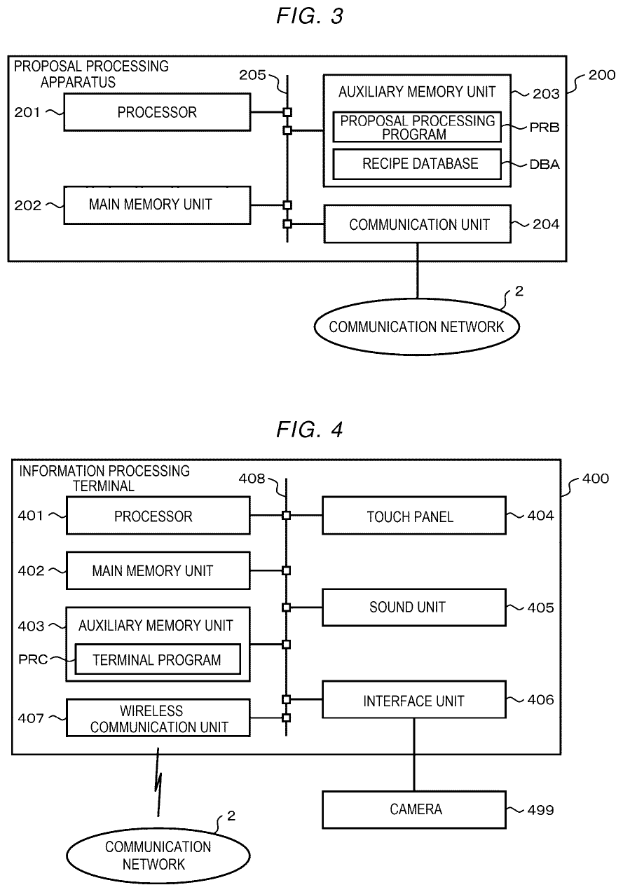

FIG. 3 is a block diagram showing a circuit configuration of a main part of the proposal processing apparatus 200.

The proposal processing apparatus 200 includes a processor 201, a main memory unit 202, an auxiliary memory unit 203, a communication unit 204, and a transmission channel 205.

Outlines of the functions of the processor 201, the main memory unit 202, the auxiliary memory unit 203, the communication unit 204, and the transmission channel 205 are equal to those of the processor 101, the main memory unit 102, the auxiliary memory unit 103, the communication unit 104, and the transmission channel 105.

Note that the auxiliary memory unit 203 stores a proposal processing program PRB in place of the transaction processing program PRA. The proposal processing program PRB is an application program describing a procedure of information processing by the processor 201 for determination of a recipe to be proposed to a customer. Note that, in the embodiment, a large-scale language model (LLM) is used as the proposal processing program PRB. Further, part of the memory area of the auxiliary memory unit 203 is used for storing a recipe database DBA. The recipe database DBA is a database fine-tuned for judgement of a recipe to be proposed to a customer by the large-scale language model.

As basic hardware of the proposal processing apparatus 200, for example, a general-purpose server apparatus may be used. The proposal processing apparatus 200 is generally transferred with the proposal processing program PRB stored in the auxiliary memory unit 203. However, hardware without the proposal processing program PRB stored in the auxiliary memory unit 203 or with the same type of application program in another version stored in the auxiliary memory unit 203 and the proposal processing program PRB may be individually transferred. Further, the proposal processing program PRB may be written in the auxiliary memory unit 203 in response to an operation by a certain worker to form the transaction processing apparatus 200. The proposal processing program PRB may be transferred by recording in a removable disc such as a magnetic disc, a magnetooptical disc, an optical disc, or a semiconductor memory or by communication via a network. The proposal processing program PRB may be stored in the main memory unit 202.

FIG. 4 is a block diagram showing a circuit configuration of a main part of the information processing terminal 400.

The information processing terminal 400 includes a processor 401, a main memory unit 402, an auxiliary memory unit 403, a touch panel 404, a sound unit 405, an interface unit 406, a wireless communication unit 407, a transmission channel 408, and the like.

Outlines of the functions of the processor 401, the main memory unit 402, the auxiliary memory unit 403, the communication unit 404, and the transmission channel 408 are equal to those of the processor 101, the main memory unit 102, the auxiliary memory unit 103, the communication unit 104, and the transmission channel 105.

Note that the auxiliary memory unit 403 stores a terminal program PRC in place of the transaction processing program PRA. The terminal program PRC is an application program describing a procedure of information processing by the processor 401 for the information processing terminal 400 to function as a user interface for registration of a transacted merchandise item in the transaction processing apparatus 100.

The touch panel 404 displays a window for information presentation to an operator. Further, the touch panel 404 inputs an instruction by a touch operation in the window by the operator. The operator of the information processing terminal 400 is usually a customer. Note that a store clerk may be the operator of the information processing terminal 400.

The sound unit 405 outputs sound and voice for various kinds of guidance and warning. As the sound unit, for example, various known sound devices including a voice synthesizing device or buzzer may be used alone or in a combination.

An external device such as a camera 499 is attached to the interface unit 406. The interface unit 406 interfaces transmission and reception of data between the connected external device and itself. As the interface unit 406, an existing USB (universal serial bus) controller or the like may be used. The camera 499 is attached to the cart and images a merchandise item held over by an operator for registration as a transacted merchandise item. A camera provided in the information processing terminal 400 may be used in place of or in addition to the camera 499.

The wireless communication unit 407 executes communication processing for wireless data communication via the communication network 2. As the wireless communication unit 407, for example, an existing wireless communication device for wireless LAN may be used. Note that a communication unit wire-connected to the communication network 2 may be used in place of or in addition to the wireless communication unit 407.

As basic hardware of the information processing terminal 400, for example, hardware of a tablet information processing apparatus may be assumed. The information processing terminal 400 is generally transferred with the terminal program PRC stored in the auxiliary memory unit 403. However, hardware without the terminal program PRC stored in the auxiliary memory unit 403 or with the same type of application program in another version stored in the auxiliary memory unit 403 and the terminal program PRC may be individually transferred. Further, the terminal program PRC may be written in the auxiliary memory unit 403 in response to an operation by a certain worker to form the information processing terminal 400. The terminal program PRC may be transferred by recording in a removable disc such as a magnetic disc, a magnetooptical disc, an optical disc, or a semiconductor memory or by communication via a network. The terminal program PRC may be stored in the main memory unit 402.

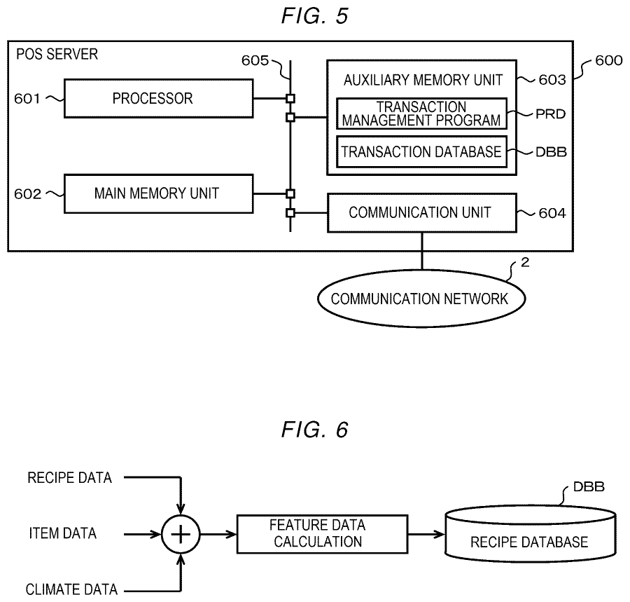

FIG. 5 is a block diagram showing a circuit configuration of a main part of the POS server 600.

The POS server 600 includes a processor 601, a main memory unit 602, an auxiliary memory unit 603, a communication unit 604, and a transmission channel 605.

Outlines of the functions of the processor 601, the main memory unit 602, the auxiliary memory unit 603, the communication unit 604, and the transmission channel 605 are equal to those of the processor 101, the main memory unit 102, the auxiliary memory unit 103, the communication unit 104, and the transmission channel 105.

Note that the auxiliary memory unit 603 stores a transaction management program PRD in place of the transaction processing program PRA. The transaction management program PRD is an application program describing a procedure of information processing by the processor 601 for management relating to transactions processed in the merchandise selling system 1. Further, part of the memory area of the auxiliary memory unit 603 is used for storing a transaction database DBB. The transaction database DBB is a database in which transaction data representing details of settled transactions with respect to each transaction is accumulated.

As basic hardware of the POS server 600, for example, a general-purpose server apparatus may be used. The POS server 600 is generally transferred with the transaction management program PRD stored in the auxiliary memory unit 603. However, hardware without the transaction management program PRD stored in the auxiliary memory unit 603 or with the same type of application program in another version stored in the auxiliary memory unit 603 and the transaction management program PRD may be individually transferred.

Further, the transaction management program PRD may be written in the auxiliary memory unit 603 in response to an operation by a certain worker to form the POS server 600. The transaction management program PRD may be transferred by recording in a removable disc such as a magnetic disc, a magnetooptical disc, an optical disc, or a semiconductor memory or by communication via a network. The transaction management program PRD may be stored in the main memory unit 602.

Next, an operation of the merchandise selling system 1 having the above described configuration will be explained. Note that the details of various kinds of processing to be described are examples and, appropriately, sequences of part of the processing can be changed, part of the processing can be omitted, or other processing can be added. For example, in the following description, to make explanation of characteristic operations of the embodiment clearer, the description of part of the processing will be omitted. For example, if some error occurs, processing for dealing with the error may be performed, however, the description of the processing will be omitted.

FIG. 6 shows a method of configuring the recipe database DBA.

First, for example, for construction of the merchandise selling system 1, as shown in FIG. 6, the recipe database DBA is obtained by fine-tuning of recipe data, selling item data, and climate data by feature data calculation and stored in the auxiliary memory unit 203 of the proposal processing apparatus 200. The recipe data represents a recipe collection of recipes to be proposed to customers. The selling item data is data on merchandise items sold in the store. The climate data is data on climates to be considered for determination of recipes. Note that the recipe database DBA may be appropriately updated even after the start of the use of the merchandise selling system 1.

A customer performs a predetermined operation for starting use in the information processing terminal 400 being unused. If the operation is performed, in the information processing terminal 400, the processor 401 executes user interface processing for the information processing terminal 400 to function as a user interface device for transaction processing based on the terminal program PRC. By the user interface processing, the processor 401 notifies the transaction processing apparatus 100 of the operation by the operator and performs an operation to notify a customer of various kinds of information under an instruction from the transaction processing apparatus 100. In the above described manner, the processor 401 first notifies the transaction processing apparatus 100 that an operation to start use is performed.

In response to the notification that an operation to start use is performed, in the transaction processing apparatus 100, the processor 101 starts transaction processing based on the transaction processing program PRA. Note that the processor 101 performs the transaction processing on the information processing terminal 400 that made the above described notification. The processor 101 may perform a plurality of pieces of transaction processing respectively for the plurality of information processing terminals 400 in parallel. Note that “information processing terminal 400” simply described in the following explanation refers to the information processing terminal 400 making the above described notification.

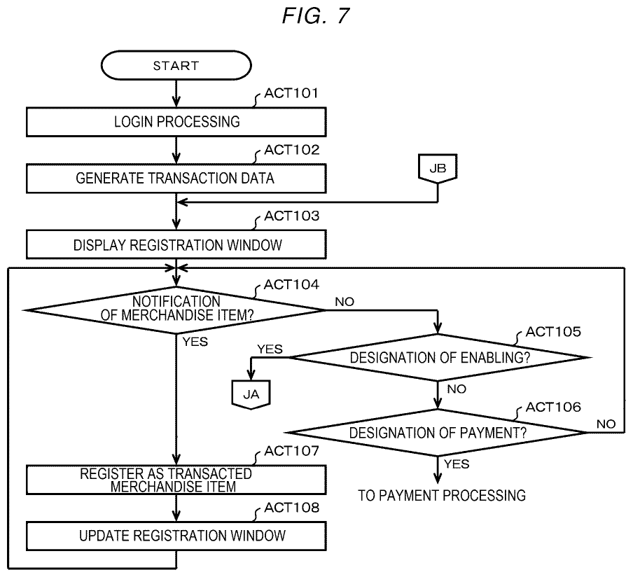

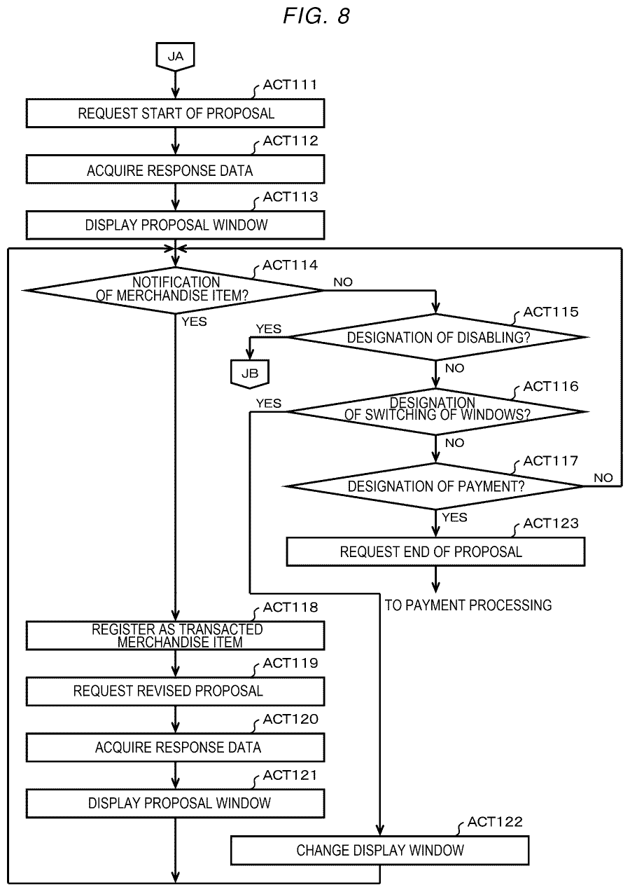

FIGS. 7 and 8 are flowcharts of the transaction processing.

As ACT 101 in FIG. 7, the processor 101 performs login processing. For example, the processor 101 displays a login window for designation of a user code and a password on the touch panel 404 in the information processing terminal 400 and receives designations of a user code and a password by a customer. Then, for example, if the processor 101 is notified of the user code and the password designated by the customer from the information processing terminal 400, the processor authenticates whether the customer is a registered user by a known user authentication technique. Then, if the processor 101 successfully authenticates the customer, the processor stores the designated user code in e.g., the main memory unit 102 or the auxiliary memory unit 103. Note that the user code read from a user card may be read by the information processing terminal 400 and the transaction processing apparatus 100 is notified thereof. Then, in the transaction processing apparatus 100, the processor 101 may perform a user authentication using the user code or not perform a user authentication and store the user code as an identification code of the customer. Further, the processor 101 may permit a login without acquisition of the user code. That is, for example, the processor 101 receives a designation of a visitor use in the login window and, if the processor is notified of the designation from the information processing terminal 400, stores a predetermined visitor code as the customer identification code in e.g., the main memory unit 102 or the auxiliary memory unit 103 without a user authentication.

As ACT 102, the processor 101 generates transaction data DAA. That is, for example, the processor 101 determines a new transaction code different from a transaction code as an identifier for identification of another transaction according to a predetermined rule, generates new transaction data DAA containing the transaction code, but not containing merchandise item information on a transacted merchandise item, and stores the data in the auxiliary memory unit 103.

As ACT 103, the processor 101 causes the touch panel 404 in the information processing terminal 400 to display a registration window. The registration window is a window for the customer to recognize a registration status of the transacted merchandise item.

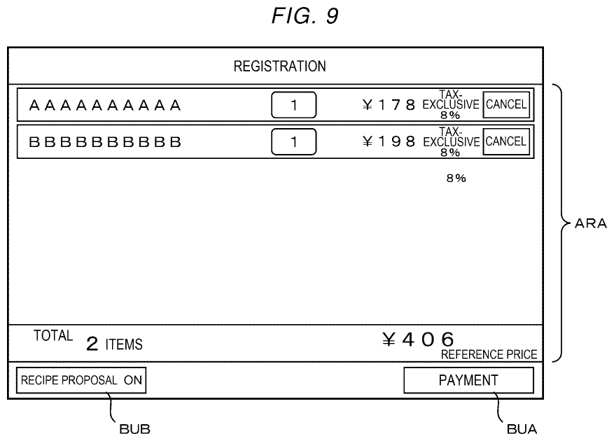

FIG. 9 shows an example of the registration window.

Note that, in all of the window examples shown in FIG. 9 and the other drawings, illustration of part of display objects may be omitted.

In the registration window shown in FIG. 9, images showing registration statuses are placed in a display area ARA. The registration window shows buttons BUA, BUB. In the example of FIG. 9, the images placed in the display area ARA show that merchandise item names are “AAAAAAAAAA” and “BBBBBBBBBB”, a total two of single merchandise items respectively at unit prices 178 yen and 198 yen are registered, and a reference price thereof is 406 yen. Note that the reference price is an amount obtained by subtraction of a discount amount of various services including a coupon service from the sum of the unit prices of all transacted merchandise items. If a transaction is settled without changes of the transacted merchandise items and the applied services, the reference price is a settled amount. The images placed in the display area ARA sequentially change according to the registration statuses of the transacted merchandise items. When the first ACT 103 after the start of transaction processing is executed, any transacted merchandise item is not yet registered, and information of each merchandise item is not shown in the display area ARA and images showing that the total zero items and the reference price zero yen are placed. The button BUA is a soft key for an operator to designate a payment. The button BUB is a soft key for the operator to designate enabling of a recipe proposal function. The details of the registration window may be appropriately determined by e.g., a creator of the terminal program PRC.

To display the registration window and various windows, which will be described later, the processor 101 generates window data representing windows in the transaction processing apparatus 100 and transmits the data to the information processing terminal 400, and the processor 401 causes the touch panel 404 to display the windows represented by the window data. Or, the processor 101 transmits various kinds of information to be displayed in the windows to the information processing terminal 400 and the processor 401 creates windows based on the information and causes the touch panel 404 to display the windows.

The customer walks around the sales floor while pushing the cart, holds merchandise items to purchase over the camera 499, and directly places the items in the cart or put the items in a basket placed on the cart.

In the information processing terminal 400, the processor 401 recognizes a merchandise item captured by the camera 499 based on an image obtained by the camera 499. That is, for example, the processor 401 performs appearance recognition processing for recognizing the merchandise item based on an appearance of the merchandise item appearing in the image. Or, for example, the processor 401 performs barcode recognition processing for recognizing the merchandise item based on a merchandise barcode on the merchandise item. Note that the processor 401 may perform both or one of the appearance recognition processing and the barcode recognition processing. Then, if the processor 401 successfully recognizes the merchandise item, the processor notifies the transaction processing apparatus 100 of a merchandise code of the merchandise item. Note that the image obtained in the information processing terminal 400 may be transmitted to the transaction processing apparatus 100 or another certain information processing apparatus and processing for merchandise recognition may be performed by the transaction processing apparatus 100 or the other certain information processing apparatus.

In the transaction processing apparatus 100, the processor 101 displays the registration window as ACT 103 in FIG. 7, and then, goes to ACT 104.

As ACT 104, the processor 101 confirms that a notification of the merchandise item is made. Then, the processor 101 judges as NO if the processor fails to confirm the event, and goes to ACT 105.

As ACT 105, the processor 101 confirms that a designation that enables the recipe proposal function is made. Then, the processor 101 judges as NO if the processor fails to confirm the event, and goes to ACT 106.

As ACT 106, the processor 101 confirms that a payment is designated. Then, the processor 101 judges as NO if the processor fails to confirm the event, and returns to ACT 104.

In the above described manner, as ACT 104 to ACT 106, the processor 101 waits until one of the notification of the merchandise item, the designation of enabling, and the designation of the payment is made.

Then, if the notification of the merchandise code is made from the information processing terminal 400 as described above, the processor 101 judges as YES in ACT 104 and goes to ACT 107.

As ACT 107, the processor 101 registers the merchandise item identified by the merchandise code of the notification as a transacted merchandise item. That is, for example, the processor 101 updates the transaction data DAA to contain merchandise item information correlated with the merchandise code of the notification as merchandise item information of the transacted merchandise item. Note that the processor 101 contains at least the merchandise code in the merchandise item information to contain in the transaction data DAA. The processor 101 may contain the merchandise item name and the unit price in the merchandise item information to contain in the transaction data DAA. Here, information that the processor 101 contains in the transaction data DAA may be appropriately determined by e.g., a person who determines the specifications of the merchandise selling system 1. The transaction data DAA is an example of list data representing a list of transacted merchandise items. In this manner, the processor 101 executes information processing based on the transaction processing program PRA, and thereby, the computer with the processor 101 as the center part functions as an update unit.

As ACT 108, the processor 101 updates the registration window. For example, the processor 101 updates the registration window displayed by the touch panel 404 in the information processing terminal 400 to show an updated list to contain the transacted merchandise item registered in ACT 107. Then, the processor 101 returns to the waiting state in ACT 104 to ACT 106. In this manner, at each time of the notification of the merchandise code, the processor 101 registers the merchandise item identified by the merchandise code as the transacted merchandise item.

Now, if the customer wishes a proposal of a recipe, for example, the customer makes a designation to enable the recipe proposal function by a predetermined operation to tap a button BUB shown in FIG. 9 or the like. Then, if the transaction processing apparatus 100 is notified of the designation from the information processing terminal 400, in the transaction processing apparatus 100, the processor 101 judges as YES in ACT 105 and goes to ACT 111 in FIG. 8. In this manner, the processor 101 executes information processing based on the transaction processing program PRA, and thereby, the computer with the processor 101 as the center part functions as a determination unit.

As ACT 111, the processor 101 requests a start of a recipe proposal to the proposal processing apparatus 200. Concurrently, the processor 101 notifies the proposal processing apparatus 200 of the merchandise item registered as the transacted merchandise item. For example, the processor 101 transmits data representing a list of all or part of merchandise codes contained in the transaction data DAA to the proposal processing apparatus 200. Or, the processor 101 may transmit the transaction data DAA as it is to the proposal processing apparatus 200. Further, the processor 101 transmits climate data on the current climate to the proposal processing apparatus 200. The climate data is data representing a weather, a temperature, humidity, etc. The information represented by the climate data may be appropriately determined by a person who determines the specifications of the merchandise selling system 1, a manager of the store, or the like. For example, the processor 101 acquires the climate data using a Web service for data distribution on climates.

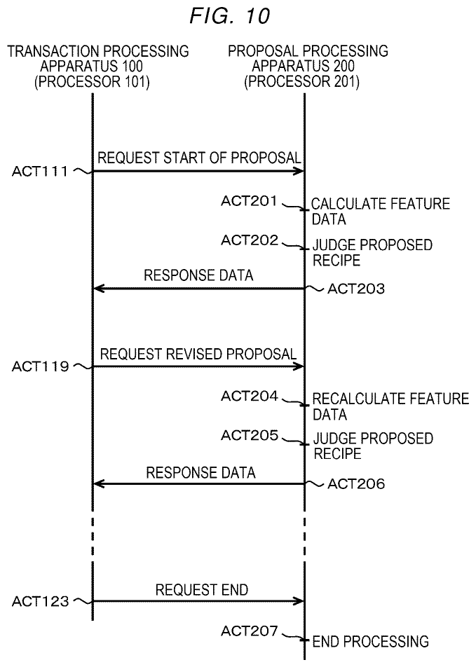

FIG. 10 is a sequence chart showing communications between the transaction processing apparatus 100 and the proposal processing apparatus 200.

If the processor 201 receives the above described request to start the recipe proposal, the processor goes to ACT 201 in the proposal processing apparatus 200.

As ACT 201, the processor 201 calculates feature data on the transacted merchandise item and the climate of the notification with the request.

As ACT 202, the processor 201 determines a recipe as an object to be proposed by the large-scale language model with reference to the recipe database DBA based on the calculated feature data. In this regard, preferably, the recipe database DBA is fine-tuned so that the processor 201 determines a recipe of a dish using the already registered transacted merchandise item and using a merchandise item not registered as the transacted merchandise item. Further, preferably, the recipe database DBA is fine-tuned so that the processor 201 determines a recipe of a dish suitable for the current climate.

As ACT 203, the processor 201 transmits response data representing recipe introduction data on the recipe determined in the above described manner to the transaction processing apparatus 100. The recipe introduction data is data representing e.g., a dish name, a list of items to purchase, and a cooking procedure. The list of items to purchase is a list of merchandise items to buy for cooking of the dish of the merchandise items sold in the store. Note that information to contain in the recipe introduction data may be appropriately determined by a person who determines the specifications of the merchandise selling system 1, a manager of the store, or the like.

In the transaction processing apparatus 100, the processor 101 requests to start the recipe proposal as ACT 111 in FIG. 8, and then, goes to ACT 112.

As ACT 112, the processor 101 acquires the response data transmitted from the proposal processing apparatus 200 as described above. That is, for example, the processor 101 stores the response data transmitted from the proposal processing apparatus 200 and received by the communication unit 104 to the main memory unit 102 or the auxiliary memory unit 103.

As ACT 113, the processor 101 causes the touch panel 404 to display a proposal window in the information processing terminal 400. The proposal window is a window for introducing the recipe determined as the object to be proposed in the above described manner to the customer.

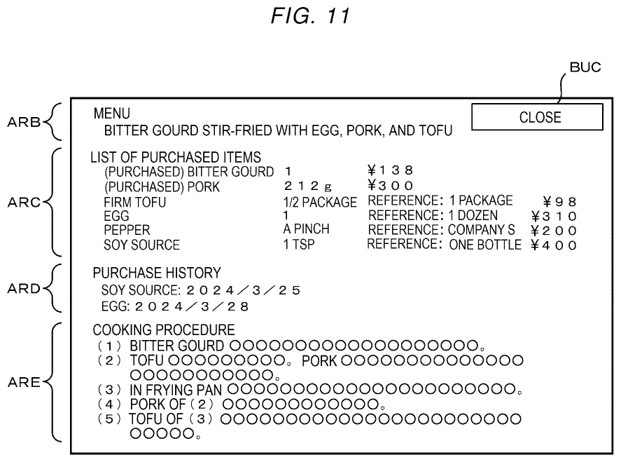

FIG. 11 shows an example of an introduction window.

In the introduction window shown in FIG. 11, a dish name is shown in an area ARB, a list of merchandise items to buy is shown in an area ARC, a list of merchandise items purchased by the customer in the past is shown in an area ARD, and a cooking procedure is shown in an area ARE. Note that, in FIG. 11, part of the characters shown in the area ARE are replaced by circles and omitted.

For example, the processor 101 loads information represented by the acquired response data in the areas ARB, ARC, ARD. For example, the processor 101 loads information on the merchandise items purchased by the customer in the past of the merchandise items to buy in the area ARD. For example, the processor 101 sends an inquiry to the POS server 600 and acquires the list of the merchandise items purchased in the past by the customer who is identified by the user code stored in the main memory unit 102 or the auxiliary memory unit 103 in ACT 101 in FIG. 7. Then, the processor 101 generates a list shown in the area ARD as a list of the same merchandise items as the merchandise items to buy of the merchandise items contained in the list of the purchased merchandise items. Note that, preferably, the list of the purchased merchandise items is based on a purchase history in a specified period determined as, for example, the last several days. If the processor 101 does not obtain the information to load in the area ARD, for example, the area ARD is left blank or the area ARD is not provided.

In the above described manner, the processor 101 acquires information on the transacted merchandise items in the previous transactions by the customer who is identified by the user code stored in the main memory unit 102 or the auxiliary memory unit 103 in ACT 101 in FIG. 7. The processor 101 executes the information processing based on the transaction processing program PRA, and thereby, the computer with the processor 101 as the center part functions as an identification unit and an acquisition unit.

A button BUC is a soft key for the operator to designate ending of the display of the introduction window and returning to display of the registration window.

In this manner, the customer may know a dish using the registered merchandise items and further know merchandise items to obtain for cooking of the dish from the introduction window. Then, if the customer determines cooking of the dish, the customer may continue registrations of transacted merchandise items to obtain the merchandise items contained in the list in the area ARC. Thereby, the display of the introduction window provides a motivation to purchase new merchandise items to the customer and is of some help to promote sales. Note that the customer may determine whether to register the merchandise item shown in the list in the area ARC as a transacted merchandise item with reference to the list shown in the area ARD. Thereby, a purchase of a merchandise item unnecessary for the customer can be prevented. This reduces the promotion effect in the shorter term for the store. However, such information presentation that benefits the customer increases customer satisfaction and a promotion effect in the longer term may be expected.

As ACT 114, the processor 101 confirms the notification of the merchandise item. Then, the processor 101 judges as NO if the processor fails to confirm the event, and goes to ACT 115.

As ACT 115, the processor 101 confirms whether a designation that disables the recipe proposal function is made. Then, the processor 101 judges as NO if the processor fails to confirm the event, and goes to ACT 116.

As ACT 116, the processor 101 confirms whether switching of windows is designated. Then, the processor 101 judges as NO if the processor fails to confirm the event, and goes to ACT 117.

As ACT 117, the processor 101 confirms that a payment is designated. Then, the processor 101 judges as NO if the processor fails to confirm the event, and returns to ACT 114.

In the above described manner, as ACT 114 to ACT 117, the processor 101 waits until one of the notification of the merchandise item, the designation of disabling, the designation of switching of windows, and the designation of the payment is made.

Then, if the notification of the merchandise code is made from the information processing terminal 400, the processor 101 judges as YES in ACT 114 and goes to ACT 118.

As ACT 118, like ACT 107 in FIG. 8, the processor 101 registers the merchandise item identified by the merchandise code of the notification as the transacted merchandise item.

As ACT 119 in FIG. 9, the processor 101 requests a revised proposal of a recipe to the proposal processing apparatus 200. In this regard, the processor 101 notifies the proposal processing apparatus 200 of the transacted merchandise item newly registered in ACT 118.

In response to the above described request for the revised proposal, the processor 201 goes to ACT 204 in FIG. 10 in the proposal processing apparatus 200.

As ACT 204, the processor 201 recalculates the feature data on the merchandise items of the notifications of the previous requests and the climate of the notification for the request to start.

As ACT 205, the processor 201 determines a recipe as an object to be proposed like ACT 202 based on the recalculated feature data.

As ACT 206, the processor 201 transmits response data representing recipe data on the recipe determined in the above described manner to the transaction processing apparatus 100.

In the transaction processing apparatus 100, after requesting the revised proposal as ACT 119 in FIG. 8, the processor 101 goes to ACT 120.

As ACT 120, the processor 101 acquires the response data transmitted from the proposal processing apparatus 200 in the above described manner. That is, for example, the processor 101 stores the response data transmitted from the proposal processing apparatus 200 and received by the communication unit 104 in the main memory unit 102 or the auxiliary memory unit 103.

As ACT 121, the processor 101 causes the touch panel 404 in the information processing terminal 400 to display a proposal window based on the response data acquired in ACT 120 like ACT 113. Then, the processor 101 returns to the waiting state in ACT 114 to ACT 117. That is, the processor 101 repeatedly executes ACT 118 to ACT 121 at each time when a new transacted merchandise item is registered and updates the proposal window in consideration of the transacted merchandise items. Concurrently, in the proposal processing apparatus 200, the processor 201 determines a recipe at each time when a new transacted merchandise item is registered. By the above described fine tuning of the recipe database DBA, the determination of the recipe corresponds processing of judging a dish using the transacted merchandise items. The display of the proposal window is an example of an operation for introducing the determined dish to the customer. That is, the processor 201 executes information processing based on the proposal processing program PRB, and thereby, the computer with the processor 201 as a center part functions as a judgement unit and an introduction unit.

If a customer wishes to confirm the registration window when the proposal window is being displayed on the touch panel 404 of the information processing terminal 400, for example, the customer designates switching of windows by a predetermined operation to tap the button BUC shown in FIG. 11 or the like.

If the transaction processing apparatus 100 is notified of the designation of switching of windows from the information processing terminal 400, in the transaction processing apparatus 100, the processor 101 judges as YES in ACT 116 in FIG. 9 and goes to ACT 122.

As ACT 122, the processor 101 changes the display on the touch panel 404 of the information processing terminal 400 to the registration window if the proposal window is displayed as described above.

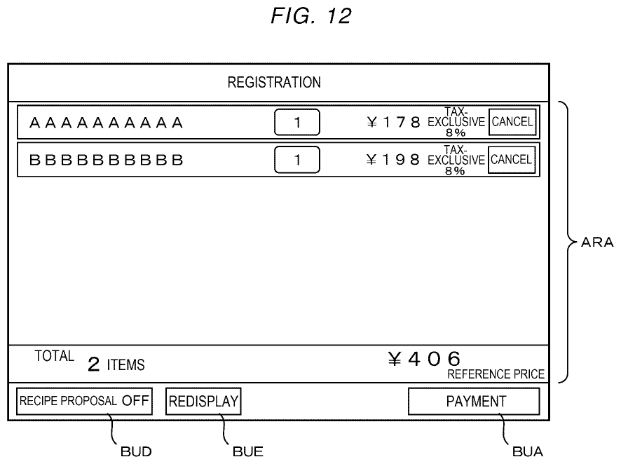

FIG. 12 shows an example of the registration window when the recipe proposal function is enabled. Note that the registration window shown in FIG. 12 is the example when the registered transacted merchandise items are the same as those in the registration window shown in FIG. 9.

The registration window shown in FIG. 12 shows a button BUD in place of the button BUB in the registration window when the recipe proposal function is disabled, i.e., the registration window shown in FIG. 9 and additionally shows a button BUE. The button BUD is a soft key for the operator to designate disabling of the recipe proposal function. The button BUE is a soft key for the operator to designate redisplay of the proposal window.

Then, the processor 101 returns to the waiting state in ACT 114 to ACT 117. If a customer wishes to confirm the proposal window again when the registration window as shown in FIG. 12 is being displayed on the touch panel 404 of the information processing terminal 400, the customer designates switching of windows by a predetermined operation to tap the button BUE or the like.

If the transaction processing apparatus 100 is notified of the designation of switching of windows from the information processing terminal 400, in the transaction processing apparatus 100, the processor 101 judges as YES in ACT 116 in FIG. 9 and goes to ACT 122. Then, the processor 101 changes the display on the touch panel 404 of the information processing terminal 400 to the proposal window displayed before the display of the registration window if the registration window is displayed as described above.

If the customer no longer needs the proposal of the recipe, for example, the customer designates disabling of the recipe proposal function by a predetermined operation to tap the button BUD or the like when the registration window shown in FIG. 12 is displayed on the touch panel 404 of the information processing terminal 400. If the transaction processing apparatus 100 is notified of the designation from the information processing terminal 400, in the transaction processing apparatus 100, the processor 101 judges as YES in ACT 115 in FIG. 8 and returns to ACT 103 in FIG. 7 and executes the subsequent actions in the same manner as those described above. Thereby, then, the processor 101 no longer displays the proposal window even if a new transacted merchandise item is registered.

If the customer finishes selecting all merchandise items to purchase, for example, the customer designates a payment by a predetermined operation to tap the button BUA shown in FIG. 9 or the like. If the transaction processing apparatus 100 is notified of the designation from the information processing terminal 400, in the transaction processing apparatus 100, the processor 101 judges as YES in ACT 106 in FIG. 7 and goes to payment processing. For example, the payment processing may be known processing for the customer to operate the payment apparatus 300 and settle a price, and the illustration and explanation thereof will be omitted. In this manner, the processor 101 executes information processing based on the transaction processing program PRA, and thereby, the computer with the processor 101 as the center part functions as a settlement unit. Note that payment processing without using the payment apparatus 300 such as online settlement processing by the processor 401 in the information processing terminal 400 may be performed.

Or, for example, the customer designates a payment by a predetermined operation to tap the button BUA shown in FIG. 12 or the like. If the transaction processing apparatus 100 is notified of the designation from the information processing terminal 400, in the transaction processing apparatus 100, the processor 101 judges as YES in ACT 117 in FIG. 8 and goes to ACT 123.

As ACT 123, the processor 101 requests an end of the recipe proposal to the proposal processing apparatus 200. Then, the processor 101 executes the above described payment processing.

In response to the request to end the recipe proposal, in the proposal processing apparatus 200, the processor 201 goes to ACT 207 in FIG. 10.

As ACT 123, for example, the processor 201 performs end processing of ending a session used for the above described communication with the transaction processing apparatus 100 and clearing data stored in the main memory unit 202 or the auxiliary memory unit 203 for the above described processing.

As described above, when the recipe proposal function is enabled, the merchandise selling system 1 proposes a recipe determined in consideration of a newly registered transacted merchandise item at each time when the transacted merchandise item is registered, to a customer. Thereby, while the customer browses in the store and adds merchandise items as transacted merchandise items, the system may propose a recipe of a dish using the transacted merchandise items registered until then. Accordingly, the recipe proposal may affect the subsequent purchase behavior of the customer and may be an introduction to the customer for whom the sales promotion is effective.

Further, the merchandise selling system 1 receives the designation of enabling/disabling of the recipe proposal function by the customer and proposes a recipe only when the function is enabled. Thereby, for example, an unnecessary introduction to a customer visiting the store after determination of merchandise items to purchase may be omitted and inconvenience of the customer may be prevented.

The following various modifications can be made to the embodiment.

Any form of introduction may be employed as long as an introduction that enables the customer to recognize a dish using the registered transacted merchandise items is performed. For example, only a dish name may be introduced. Even in the case, a promotion effect may be expected from a customer who may find merchandise items to purchase from the dish name.

For the determination of the recipe to be proposed, the climate is not necessarily considered.

For example, the introduction may be made by another method than the window display such as output of a sound message or mail transmission.

In the information processing terminal 400, the processor 401 may execute part or all of the transaction processing. Or, any information processing apparatus including the POS server 600 may perform part or all of the transaction processing.

The above described processing by the proposal processing apparatus 200 may be performed by the transaction processing apparatus 100, the POS server 600, or any other information processing apparatus.

Part or all of the respective functions implemented by the processors 101, 201, 401 by information processing can be implemented by hardware such as a logic circuit executing information processing not based on a program. Further, the individual functions can be implemented by a combination of the hardware such as a logic circuit with software control.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transaction processing system, comprising:
an updating component, at each time when a merchandise item is designated through an operation by a customer, for updating list data representing a list of transacted merchandise items to contain the merchandise item as a transacted merchandise item;
a settling component for settling a price of the transacted merchandise item contained in the list represented by the list data in response to a designation of a settlement;
a judging component, at each time when the list data is updated by the updating component, for judging the dish using a transacted merchandise item contained in a list represented by the updated list data; and
an introducing component for introducing a dish judged by the judging component to the customer.

2. The transaction processing system according to claim 1, further comprising a determining component for determining whether an introduction by the introducing component is performed by a designation by the customer, wherein
the judging component judges a dish if the determining component determines that an introduction is performed.

3. The transaction processing system according to claim 1, further comprising:
an identifying component for identifying a customer; and
an acquiring component for acquiring information on transacted merchandise items in previous transactions relating to the customer identified by the identifying component, wherein
the introducing component introduces the information acquired by the acquiring component with the dish judged by the judging component to the customer.

4. The transaction processing system according to claim 1, wherein
the judging component judges the dish using the transacted merchandise item contained in the list represented by the updated list data in consideration of a climate.

5. The transaction processing system according to claim 1, wherein
the judging component judges a dish using another merchandise item than the transacted merchandise item in addition to the dish using the transacted merchandise item contained in the list represented by the updated list data.

6. The transaction processing system according to claim 1, wherein
the identifying component identifies the customer via a user code and a password.

7. A transaction processing method, comprising:
at each time when a merchandise item is designated through an operation by a customer, updating list data representing a list of transacted merchandise items to contain the merchandise item as a transacted merchandise item;
settling a price of the transacted merchandise item contained in the list represented by the list data in response to a designation of a settlement;
at each time when the list data is updated by the updating component, judging the dish using a transacted merchandise item contained in a list represented by the updated list data; and
introducing a dish judged by the judging component to the customer.

8. The transaction processing method according to claim 7, further comprising:
determining whether an introduction is performed by a designation by the customer; and
judging a dish if determining that an introduction is performed.

9. The transaction processing method according to claim 7, further comprising:
identifying a customer;
acquiring information on transacted merchandise items in previous transactions relating to the customer identified by the identifying component; and
introducing the information acquired with the dish judged to the customer.

10. The transaction processing method according to claim 7, further comprising:
judging the dish using the transacted merchandise item contained in the list represented by the updated list data in consideration of a climate.

11. The transaction processing method according to claim 7, further comprising:
judging a dish using another merchandise item than the transacted merchandise item in addition to the dish using the transacted merchandise item contained in the list represented by the updated list data.

12. The transaction processing method according to claim 7, further comprising:
identifying the customer via a user code and a password.

13. A non-transitory computer storage medium comprising a program configured to execute:
at each time when a merchandise item is designated through an operation by a customer, updating list data representing a list of transacted merchandise items to contain the merchandise item as a transacted merchandise item;
settling a price of the transacted merchandise item contained in the list represented by the list data in response to a designation of a settlement;
at each time when the list data is updated by the updating component, judging the dish using a transacted merchandise item contained in a list represented by the updated list data; and
introducing a dish judged by the judging component to the customer.

14. The non-transitory computer storage medium according to claim 13, further comprising:
determining whether an introduction is performed by a designation by the customer; and
judging a dish if determining that an introduction is performed.

15. The non-transitory computer storage medium according to claim 13, further comprising:
identifying a customer;
acquiring information on transacted merchandise items in previous transactions relating to the customer identified by the identifying component; and
introducing the information acquired with the dish judged to the customer.

16. The non-transitory computer storage medium according to claim 13, further comprising:
judging the dish using the transacted merchandise item contained in the list represented by the updated list data in consideration of a climate.

17. The non-transitory computer storage medium according to claim 13, further comprising:
judging a dish using another merchandise item than the transacted merchandise item in addition to the dish using the transacted merchandise item contained in the list represented by the updated list data.

18. The non-transitory computer storage medium according to claim 13, further comprising:
identifying the customer via a user code and a password.
